(19) United States
(12) Patent Application Publication
(10) Pub. No.: US 2025/0127285 A1
(43) Pub. Date: Apr. 24, 2025

(54) WEARABLE APPLIANCE FOR CARRYING MOBILE DEVICE

(71) Applicant: SHENZHEN NEEWER TECHNOLOGY CO. LTD, Shenzhen (CN)

(72) Inventors: Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/491,199

(22) Filed: Oct. 20, 2023

(51) Int. Cl. A45F 5/00; G03B 17/56; H04M 1/05

(52) U.S. Cl. CPC A45F 5/00; H04M 1/05; A45F 2005/006; A45F 5/1516; G03B 17/561

(57) ABSTRACT

Disclosed is a wearable appliance for carrying a mobile device. The wearable appliance includes a flexible strip and a mounting assembly connected to the flexible strip. The flexible strip is configured to encircle a user's neck and is capable of deforming to a shape when subjected to an external force and maintaining the shape of the flexible strip when the external force is removed. The mounting assembly is configured to fix the mobile device.

### TECHNICAL FIELD

The present application relates to the technical field of mobile device accessories, in particular to a wearable appliance for carrying a mobile device.

### BACKGROUND

In our daily life, a camera or a smart phone is generally attached to a strip worn around the user's neck for carrying the camera or the smart phone, the strip is typically made of leather or cloth, and the camera or the smart phone is placed on the user's chest.

### SUMMARY

However, because the strip is typically made of leather or cloth, so there exists a problem that the camera or the smart phone will easily wobble or even turn over, thereby affecting the shooting of the camera or the smart phone.

The present application introduces a wearable appliance for carrying a mobile device aiming to solve the above mentioned problem, and the wearable appliance includes a flexible strip and a mounting assembly. The flexible strip is configured to encircle a user's neck, and is capable of deforming to a shape when subjected to an external force and maintaining the shape of the flexible strip when the external force is removed. The mounting assembly is connected to the flexible strip, and is configured to fix the mobile device.

In some embodiments, the flexible strip is made of an aluminum bar and a covering material, the covering material is covered on an outer surface of the aluminum bar.

In some embodiments, the wearable appliance further includes a steel wire, the steel wire is wound onto the aluminum bar, and the covering material is covered on an outer surface of the steel wire.

In some embodiments, the covering material includes silicon, plastic, rubber or the mixture of them.

In some embodiments, the flexible strip includes a first connecting end and a second connecting end, the first connecting end is fixed to the mounting assembly, and the second connecting end is detachably connected to the mounting assembly.

Further, in some embodiments, the second connecting end is provided with a locking hole, the mounting assembly includes a housing, a first button, and a first locking member. The first locking member is provided inside the housing and coupled to the first button. The first button is movably mounted on the housing. The housing is provided with a plughole. The locking hole is locked with the first locking member when the second connecting end is inserted into the plughole, and the locking hole is unlocked with the first locking member when the first button is pressed down.

Further, in some embodiments, the first locking member includes a first locking piece and a first spring. The first locking piece is provided with an inserting latch which is perpendicular to the first locking piece, and the first spring abuts against the first locking piece and the housing to provide an elastic force to the first locking piece.

Further, in some embodiments, the first button is provided with an identification portion for indicating a location of the second connecting end.

In some embodiments, the mounting assembly includes a housing and a mounting member, the flexible strip is connected to the housing, and the mounting member is detachably connected to the housing, the mounting member is configured to fix the mobile device.

Further, in some embodiments, the housing is provided with a mounting recess, an outer edge of the mounting recess is provided with one or more flanges. The mounting member includes a mounting portion and a connecting portion, the mounting portion is configured to fit with the mounting recess and provided with one or more flanges on a periphery of the mounting portion. The connecting portion is configured to fix the mobile device.

Further, in some embodiments, the mounting assembly further includes a second button and a second locking member coupled to the second button. The second button is movably mounted on the housing. The second locking member is provided inside the housing. The mounting portion is locked with the second locking member when the mounting member is rotated to a preset position in the mounting recess, and the mounting portion is unlocked with the second locking member when the second button is pressed down.

Further, in some embodiments, the connecting portion includes a plurality of clamping plates, a nut, and a bolt. Each of the plurality of clamping plates is provided with a connecting hole. The plurality of clamping plates are arranged in parallel to each other and connected to the mounting portion. The nut is mounted on a clamping plate located at an outermost side of the plurality of clamping plates and corresponding to the connecting hole, and the bolt is configured to be threaded through the connecting hole and threaded with the nut.

Further, in some embodiments, the mounting assembly further includes a first magnetic piece and a second magnetic piece attracting each other by magnetic force, the first magnetic piece is provided in the housing, and the second magnetic piece is provided in the mounting member.

In some embodiments, the mounting assembly includes a housing and a mounting member, the mounting member is detachably connected to the housing, and the mounting member is configured to fix the mobile device, the flexible strip includes a first connecting end and a second connecting end, the first connecting end is fixed to the housing, and the second connecting end is detachably connected to the housing. The mounting assembly further includes two buttons movably mounted on the mounting assembly. One of the two buttons is configured to control the connection between the housing and the second connecting end, and the other button is configured to control the connection between the mounting member and the housing. An end face of one of the two buttons exposed to an outer side of the housing is a concave surface, and an end face of the other button exposed to the outer side of the housing is a convex surface.

In some embodiments, a hanging portion is formed at a middle of the flexible strip, and a diameter of the hanging portion is larger than diameters of other portions of the flexible strip.

Further, in some embodiments, a surface of the hanging portion is provided with slip-proof stripes.

### BRIEF DESCRIPTION OF THE DRAWINGS

In order to more clearly illustrate the technical solutions in the embodiments of the present application or in the prior art, drawings that are needed to illustrate the embodiments and the prior art are simply introduced below. Obviously, drawings introduced below are just some of the embodiments in the present application. For those of ordinary skill in the art, other figures may be further obtained without creative efforts according to the structures shown in drawings below.

FIG. 1 is a schematic structural view of a wearable appliance for carrying a mobile device according to an embodiment of the present application.

FIG. 2 is an enlarged schematic view of part A in FIG. 1 showing two buttons of the wearable appliance according to an embodiment of the present application.

FIG. 3 is an enlarged schematic view of part A in FIG. 1 showing two buttons of the wearable appliance according to another embodiment of the present application.

FIG. 4 is a schematic structural view showing the wearable appliance in FIG. 1 being in a disassembled state.

FIG. 5 is a schematic structural view showing the wearable appliance in FIG. 4 being in an assembled state.

FIG. 6 is a schematic structural view showing a connecting portion of a mounting member of the wearable appliance in FIG. 5 being in a disassembled state.

FIG. 7 is another schematic structural view showing the wearable appliance in FIG. 1 being in a disassembled state.

FIG. 8 is an enlarged schematic structural view of part B in FIG. 7.

FIG. 9 is an enlarged schematic structural view of part C in FIG. 7.

FIG. 10 is a schematic structural view of the mounting member of the wearable appliance in FIG. 1.

FIG. 11 is a schematic structural view of a flexible strip of the wearable appliance in FIG. 1.

FIG. 12 is an enlarged schematic structural view of part D in FIG. 11.

FIG. 13 is another schematic structural view of the wearable appliance in FIG. 1.

FIG. 14 is a cross-sectional view of the wearable appliance in FIG. 13 along X-X direction.

FIG. 14-1 to FIG. 14-3 are the schematic views showing the working principle of the first locking member.

FIG. 15 is a cross-sectional view of the wearable appliance in FIG. 13 along Y-Y direction.

FIG. 16 is an enlarged schematic structural view of part E in FIG. 15.

FIG. 17 is an enlarged schematic structural view of part F in FIG. 15.

The realization of the purpose, the functional feature, and the advantage of present application will be further illustrated referring to the drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all the embodiments of the present application. All other embodiments obtained by those skilled in the art based on the embodiments of the present application without creative efforts shall fall within the scope of the present application.

It should be noted that all the directional indications (such as up, down, left, right, front, rear, etc.) in the embodiments of the present application are only used to explain the relative positional relationship, movement, or the like of the components in a certain posture (as shown in the drawings). If the specific posture changes, the directional indication will change accordingly.

In the present application, unless otherwise specifically specified and limited, the terms “connected” should be understood in a broad sense, for example, “connected” can be a mechanical connection or an electrical connection; can be directly connected, or indirectly connected through an intermediate medium, or can be the internal communication between two elements or the interaction relationship between two elements. Meanwhile, the term “fix” could be understood as one part being mounted on another part in any kind of connection, such as a detachable connection, as long as they are fixed together. For those skilled in the art, the specific meaning of the above-mentioned terms in the present application can be understood according to specific situations.

Besides, the descriptions associated with, e.g., “first” and “second” in the present application are merely for descriptive purposes, and cannot be understood as indicating or suggesting relative importance or impliedly indicating the number of the indicated technical feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

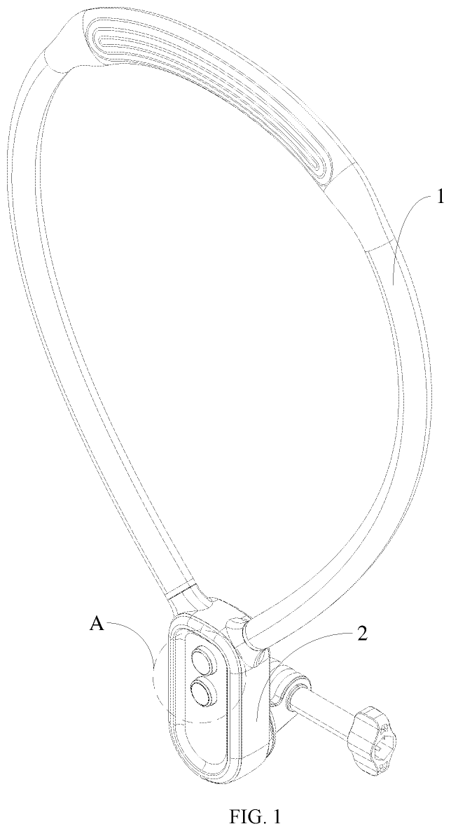

Please refer to FIG. 1, the wearable appliance for carrying a mobile device includes a flexible strip 1 and a mounting assembly 2. The flexible strip 1 is configured to encircle a user's neck, and is capable of deforming to a shape when subjected to an external force and maintaining the shape of the flexible strip when the external force is removed. That is, the flexible strip 1 can deform into a suitable shape to encircle the user's neck when the user uses his/her hands to hold the flexible strip 1 and presses or pulls with a certain force, and after the flexible strip 1 is wound around the user's neck properly, the flexible strip 1 can maintain the shape of the flexible strip, and the user can uses his/her hands to fix the mobile device to the mounting assembly 2. Since the mounting assembly 2 is connected to the flexible strip 1 and the flexible strip 1 is well worn on the user's neck, and the shape of the flexible strip can be maintained on the user's neck, so the flexible strip 1 is hard to wobble or turn over, the mobile device connected to the wearable appliance is less likely to wobble or turn over, and thereby bringing a better working condition for the shooting of the mobile device.

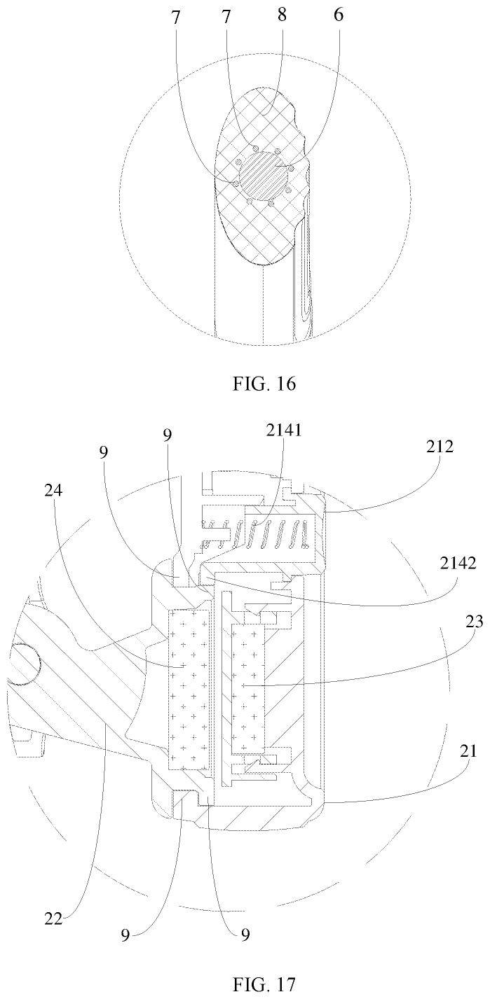

In order to achieve the above technical effects, the flexible strip 1 may be made of aluminum bar or steel bar or the like, and the flexible strip 1 may further include a rubber cover or a silicone cover covered on the aluminum bar or the steel bar, or the flexible strip 1 may be made of aluminum wire, steel wire, and silicone, the aluminum wire and the steel wire are twisted together and covered with the silicone, rubber or plastic or the mixture of them. Please refer to FIG. 16, in one embodiment of the present application, the flexible strip 1 is made of aluminum bar 6, steel wire 7, and silicone 8, the steel wire 7 is wound onto the aluminum bar 6, and the silicone 8 is covered on an outer surface of the flexible strip 1. The aluminum bar 6 can provide the effect of maintaining the shape of the flexible strip 1 and deforming when subjected to an external force, the steel wire 7 can provide the effect of improving the fatigue resistance of the flexible strip 1, and the silicone 8 can not only prevent the steel wire 7 from being exposed to the air and rusting, but also provide a soft tactile sense to the user and improve the slip resistance of the flexible strip 1.

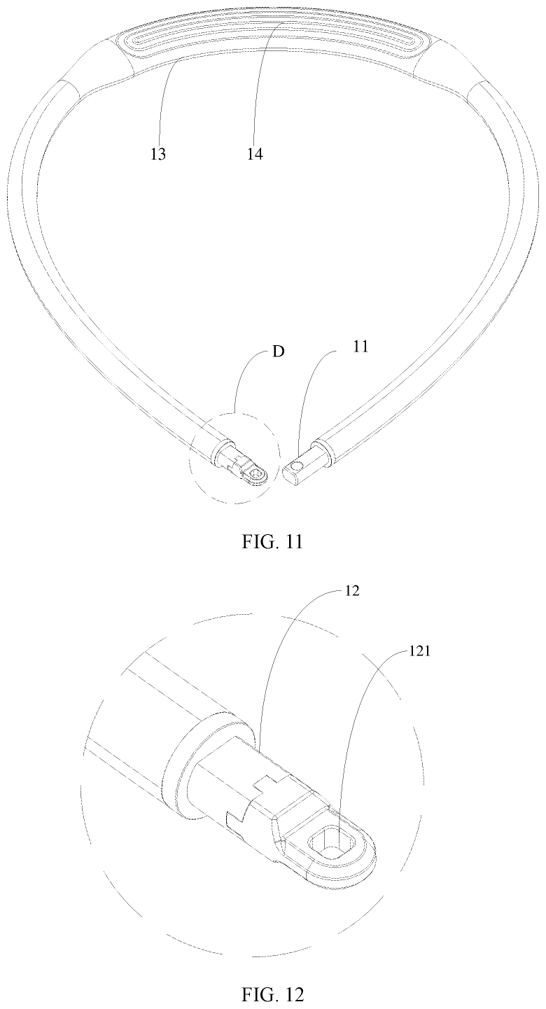

Please refer to FIG. 11, in one embodiment of the present application, a hanging portion 13 is formed at a middle of the flexible strip 1, and a diameter of the hanging portion 13 is larger than diameters of other portions of the flexible strip 1, and then the contact area between the flexible strip 1 and the user's neck is increased, the pressure applied by the wearable appliance and the mobile device to the user's neck is reduced, which brings a better user experience. Further, please refer to FIG. 11 again, in another embodiment of the present application, a surface of the hanging portion 13 is provided with slip-proof stripes 14, which further improves the slip resistance of the flexible strip 1 and the stability of the mobile device on the wearable appliance.

What can be understood is that the mobile device could be a smart phone, a digital camera, or other small portable camera, and the mounting assembly 2 could be a handle with a cold shoe or other common camera mount. The mounting assembly 2 could be provided with a hole to thread the flexible strip 1 for connecting the mounting assembly 2 and the flexible strip 1, and the mounting assembly 2 could also be made together with the flexible strip 1. The flexible strip 1 may include two connecting ends, one of the connecting ends may be fixed to the mounting assembly 2, and the other connecting end may be detachably connected to the mounting assembly 2, and in other embodiment, the two connecting ends may all be detachably connected to the mounting assembly 2. The mounting assembly 2 may be provided with two screw holes, the two connecting ends may include external thread sections, and the two connecting ends may be connected to the mounting assembly 2 by threaded connection.

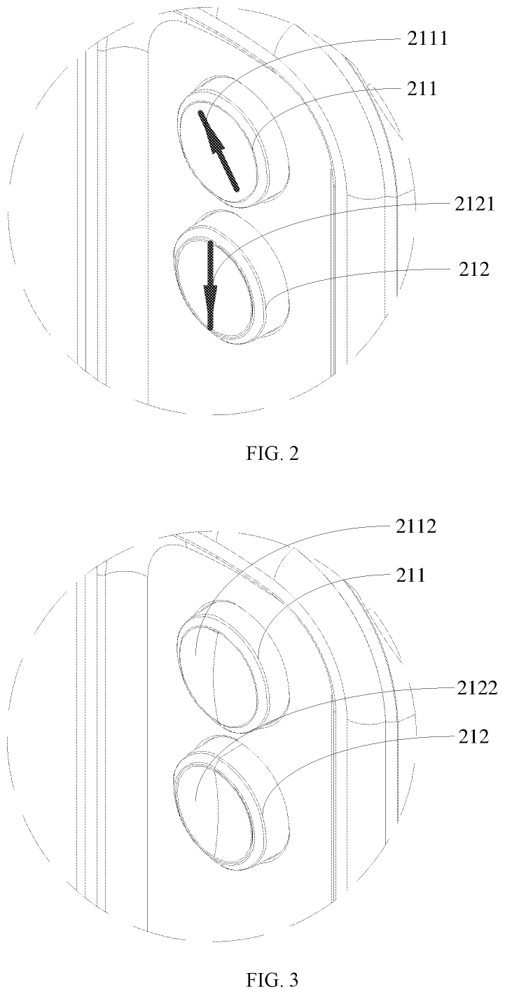

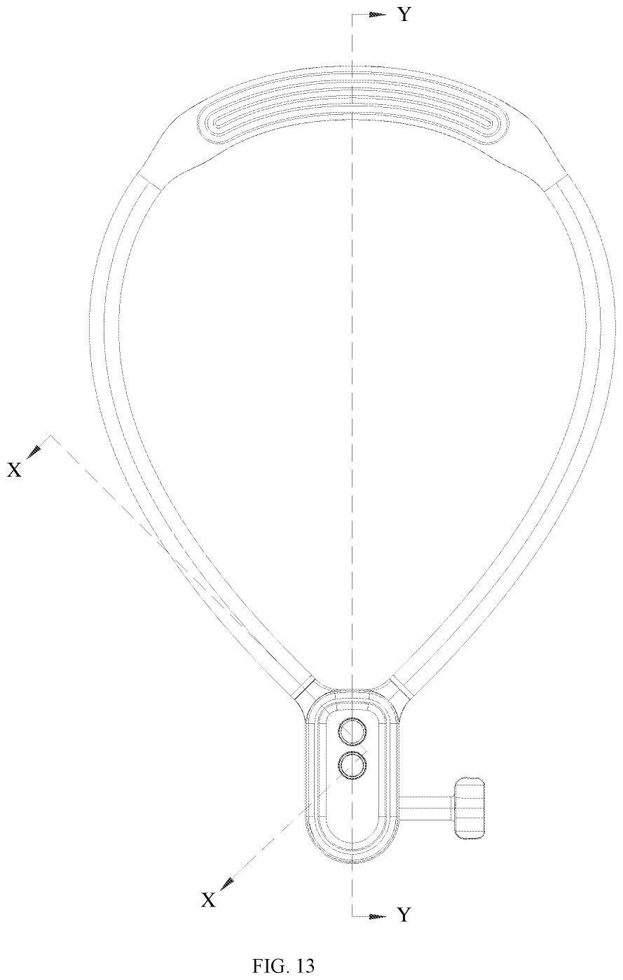

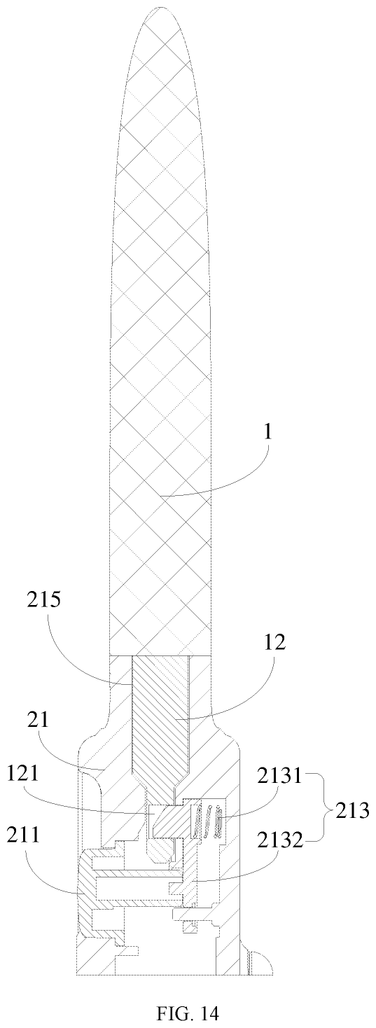

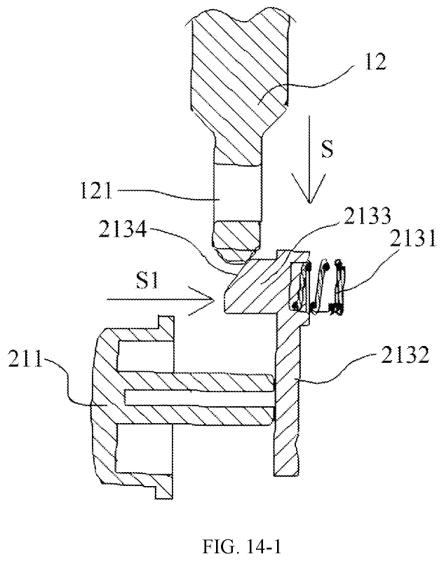

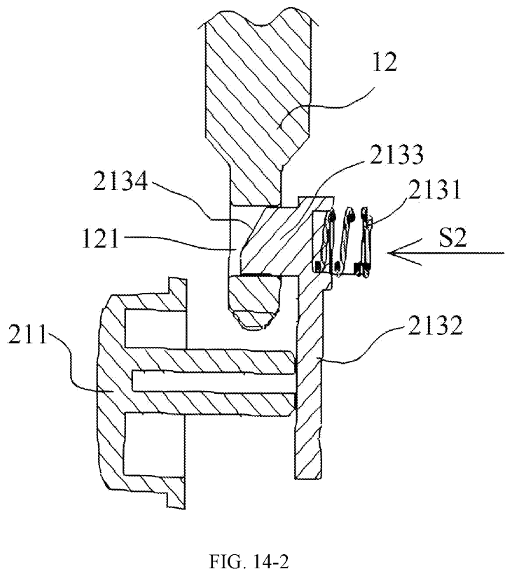

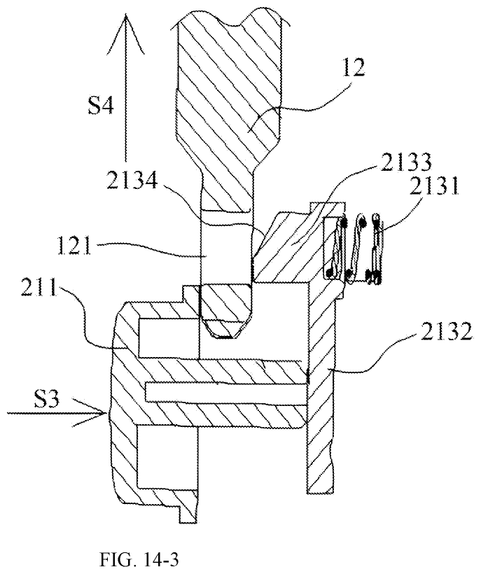

In one embodiment of the present application, please refer to FIGS. 11 to 14, the flexible strip 1 includes a first connecting end 11 and a second connecting end 12. The second connecting end 12 is provided with a locking hole 121. The mounting assembly 2 includes a housing 21, a first button 211, and a first locking member 213. The first locking member 213 is provided inside the housing 21 and coupled to the first button 211. The first locking member 213 includes a first spring 2131, a first locking piece 2132 and a inserting latch 2134 with a inclining surface 2133 facing the entrance of the plughole 215 protrudes from the first locking piece 2132, the first locking piece 2132 is movably provided inside the housing 21, and the first spring 2131 is abutted against one side of the first locking piece 2132 and the inner wall of the housing 21 to provide an elastic force to the first locking piece 2132. The first button 211 is movably mounted on the housing 21, and is abutted against the other side of first locking piece 2132. The housing 21 is provided with a plughole 215. According to FIG. 14-1, FIG. 14-2, and FIG. 14-3, when the second connecting end 12 is inserted into the plughole 215 along the direction S, the edge of the second connecting end 12 touches and pushes the inclining surface 2133 of the inserting latch 2134, then presses the inclining surface 2133 along the direction S1, then the first locking piece 2132 move to a side, when the locking hole 121 of the second connecting end 12 moves to the position where the locking hole 121 is facing the inserting latch 2134, the inserting latch 2134 moves into the locking hole 121 along the direction S2 under the force of the first spring 2131, shown in FIG. 14-2, and then the first locking piece 2132 is locked with the locking hole 121 due to the elastic force provided by the first spring 2131. According to FIG. 14-3, when the first button 211 is pressed down along the direction S3, the first locking piece 2132 is pressed against the first spring 2131 until being out of the locking hole 121 and unlocked with the locking hole 121, and then the second connecting end 12 of the flexible strip 1 could be pulled out from the plughole 215 along the direction S4 and detached from the mounting assembly 2. When using the wearable appliance, the user can firstly press the first button 211 to pull out the second connecting end 12, and then wear the wearable appliance on the neck, then insert the second connecting end 12 into the plughole 215 so as to lock the second connecting end 12 with the mounting assembly 2, and finally hold the flexible strip 1 and press or pull the flexible strip 1 to adjust it into a proper shape for a more stable shooting condition of the mobile device.

What can be understood is that the first locking member 213 mentioned above may be an elastic steel plate, one end of the elastic steel plate is fixed while the other end is free and configured to be locked or unlocked with the locking hole 121, and the first button 211 is abutted against a position between the fixed end and free end. When the elastic steel plate is in a free state, it can be locked with the connecting hole when the second connecting end 12 is inserted into the plughole 215, and by pressing the first button 211, the elastic steel plate could deform and be unlocked with the locking hole 121.

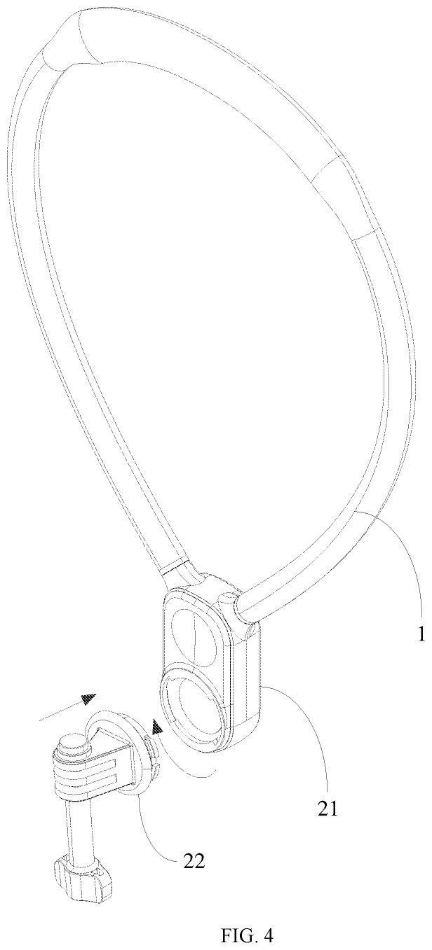

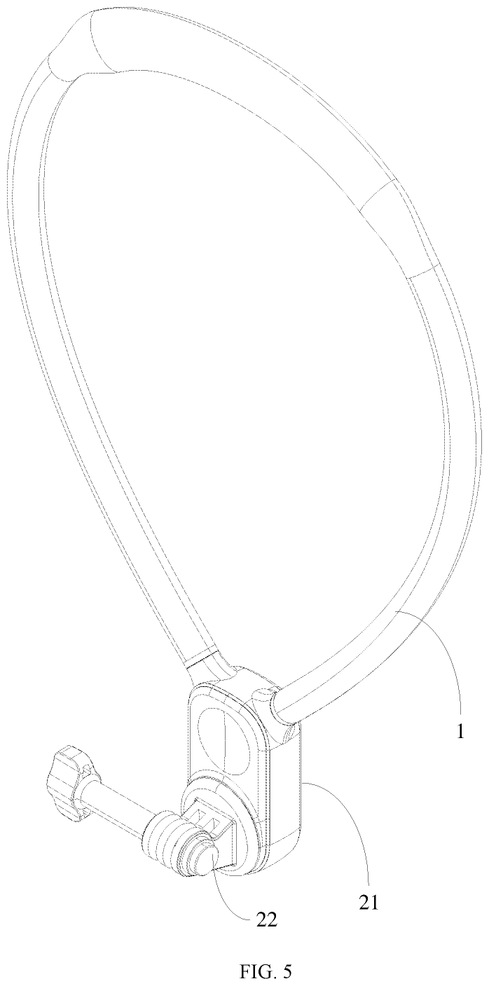

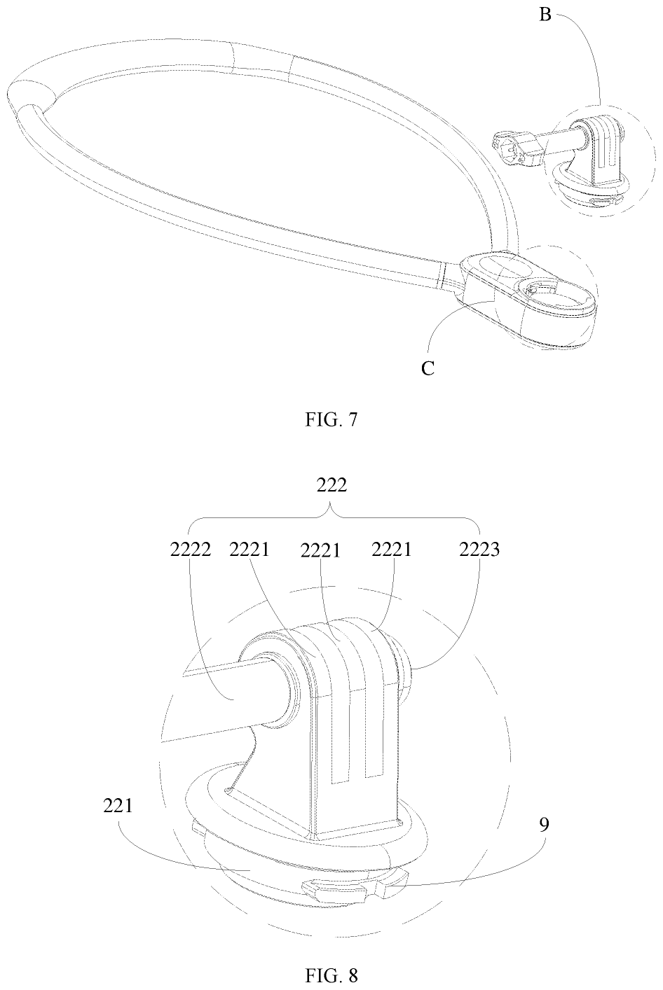

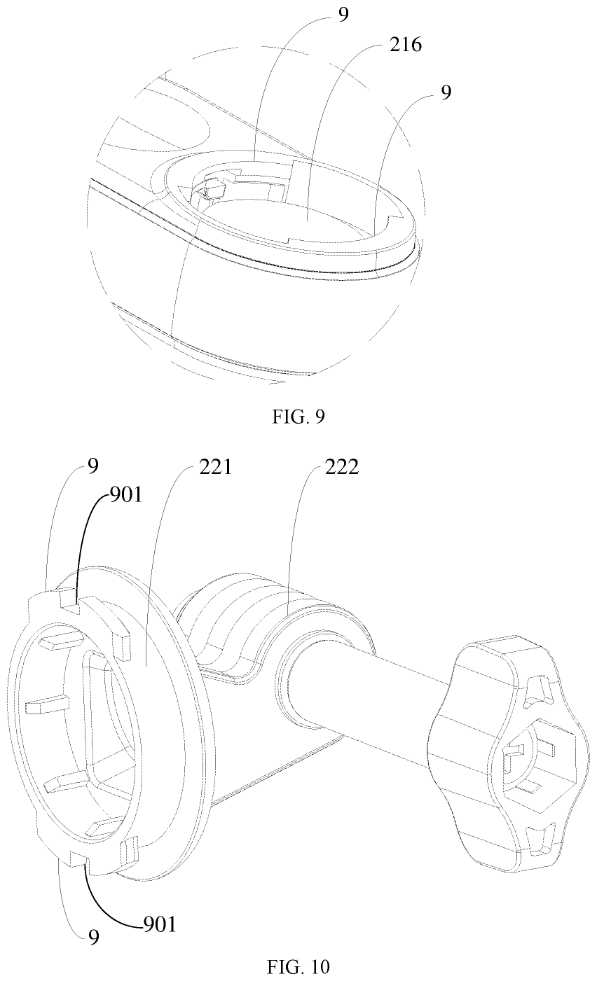

In the present application, the mounting assembly 2 may include two members, one of which is fixed to the flexible strip 1 while the other member is detachably connected to the preceding member and is configured to connect the mobile device, and the two members could be in threaded connection. In an embodiment of the present application, please refer to FIGS. 4 to 10, the mounting assembly 2 includes a housing 21 and a mounting member 22, the flexible strip 1 is connected to the housing 21, and the mounting member 22 is detachably connected to the housing 21, the mounting member 22 is used to fix the mobile device. The housing 21 is provided with a mounting recess 216. In one embodiment, the cross section of the mounting recess 216 may be circle, an outer edge closing to the entrance of the mounting recess 216 is provided with two flanges 9. The mounting member 22 includes a mounting portion 221 and a connecting portion 222, and the mounting portion 221 is configured to fit with the mounting recess 216 and provided with two flanges 9 on a periphery of the mounting portion 221. The connecting portion 222 is used to fix the mobile device. As shown in FIGS. 4 and 5, the mounting member 22 could be firstly inserted into the mounting recess 216 along the direction indicated by the straight line arrow in FIG. 4, after the mounting portion 221 is inserted into the mounting recess 216, the two flanges 9 of the mounting portion 221 are located under the two flanges 9 of the mounting recess 216, and rotating the mounting member 22 about 90 degrees in a clockwise direction (or a counterclockwise direction) shown in FIG. 4 until the flanges 9 on the mounting recess 216 facing the flanges 9 of the mounting portion 221, and the flanges 9 on the mounting portion 221 abut against the flanges 9 on the recess 216, so the flanges 9 on the mounting recess 216 are clamped with those on the mounting portion 221 of the mounting member 22 (as shown in FIG. 17), and the mounting member 22 is finally connected to the housing 21 as shown in FIG. 5. In other possible embodiments, the housing 21 could be provided with internal thread, the mounting member 22 could be provided with external thread, and the housing 21 is in threaded connection with the mounting member 22. In other possible embodiments, the outer edge of the mounting recess 216 could be provided with one or three or more flanges 9, and the mounting portion 221 of the mounting member 22 could be provided with one or three or more flanges 9 accordingly as long as the basic detachable connection between the housing 21 and the mounting member 22 could be realized.

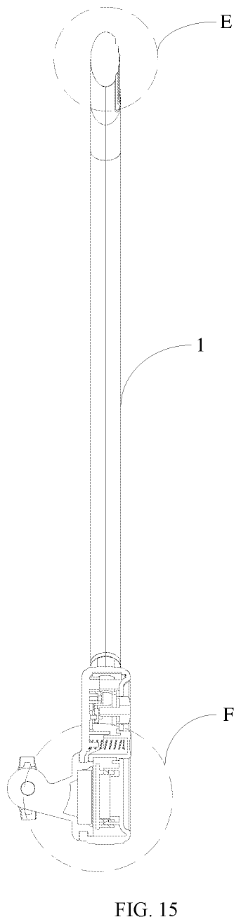

In order to further improve the reliability of the connection between the housing 21 and the mounting member 22, please refer to FIGS. 13, 15, and 17, in an embodiment of the present application, the mounting assembly 2 further includes a second button 212 and a second locking member coupled to the second button 212. The second button 212 is movably mounted on the housing 21, the second locking member is provided inside the housing 21. The mounting portion 221 is locked with the second locking member when the mounting member 22 is rotated to a preset position in the mounting recess 216, and the mounting portion 221 is unlocked with the second locking member when the second button 212 is pressed down. Specifically, the second locking member includes a second spring 2141 and a second locking piece 2142, the second locking piece 2142 is connected to or formed at the second button 212, and the second spring 2141 is abutted against the housing 21 and the second button 212. The mounting portion 221 could be provided with a gap 901 or a hole at the flanges 9 (as shown in FIG. 10), and when the mounting member 22 is rotated to a preset position, i.e., where the second locking piece 2142 could be inserted in the gap 901 or the hole and be locked with the flanges 9 on the mounting portion 221 under an elastic force provided by the second spring 2141, so the mounting member 22 can't rotate freely and then the mounting member 22 is completely locked with the housing 21, thus a reliable connection between the housing 21 and the mounting member 22 is realized. In other possible embodiments, the second locking member could resemble the first locking member 213 in structure to achieve the same technical effect.

In order to facilitate the installing of the mounting member 22 to the housing 21, please refer to FIG. 17, in an embodiment of the present application, the mounting assembly 2 further includes a first magnetic piece 23 and a second magnetic piece 24 attracting each other by magnetic force. The first magnetic piece 23 is provided in the housing 21, and the second magnetic piece 24 is provided in the mounting member 22. The two magnetic pieces could be a pair of magnets or other possible parts as long as they can attract each other by magnetic force.

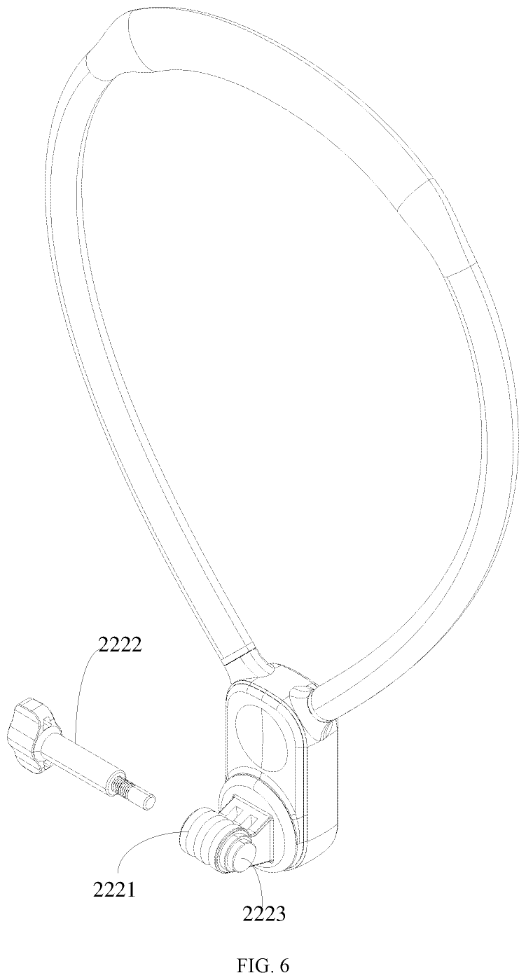

Please refer to FIGS. 6 to 8, in an embodiment of the present application, the connecting portion 222 includes three clamping plates 2221, a nut 2223, and a bolt 2222. Each of the three clamping plates 2221 is provided with a connecting hole, and the three clamping plates 2221 are arranged in parallel to each other and connected to the mounting portion 221. The nut 2223 is mounted on a clamping plate located at an outermost side of the three clamping plates 2221 and corresponding to the connecting hole, and the bolt 2222 is configured to be threaded through the connecting hole and threaded with the nut 2223. The gaps defined between the adjacent clamping plates 2221 could be configured to accommodate those clamping plates 2221 formed at or connected to the mobile device, and the bolt 2222 is configured to be threaded through all the connecting holes of the clamping plates 2221 on both the mounting assembly 2 and the mobile device, and after the bolt 2222 is threaded with the nut 2223, the mobile device is fixed to the mounting assembly 2. The number of clamping plates 2221 provided to the mounting assembly 2 could be adjusted according to the certain situation and the type of the mobile device.

Since the first connecting end 11 is fixed to the mounting assembly 2, and the second connecting end 12 is detachably connected to the mounting assembly 2, so based on the above embodiments, please refer to FIGS. 1 and 2, in another embodiment of the present application, the first button 211 is provided with a first identification portion 2111 for indicating a location of the second connecting end 12, and the user can easily distinguish the first connecting end 11 and the second connecting end 12 and can choose the correct end to pull out, thereby improving the user's experience. Similarly, the second button 212 could also be provided with a second identification portion 2121 for indicating the location of the mounting member 22. The identification portion could be an arrow-like pattern printed on the button or molded on the button. Similarly, in another embodiment of the present application, as shown in FIG. 3, an end face of the first button 211 exposed to the outer side of the housing 21 is a convex surface 2112, and an end face of the second button 212 exposed to the outer side of the housing 21 is a concave surface 2122, and the user can easily distinguish the first button 211 and the second button 212 to select the correct button to press down, so as to realize an eyes-free operation. Also, the end face of the first button 211 exposed to the outer side of the housing 21 could be a concave surface, and the end face of the second button 212 exposed to the outer side of the housing 21 could be a concave surface, and the same technical effect can also be realized. In addition, in other possible embodiments, the concave surface 2122 and the convex surface 2112 could also be provided with identification portions to indicate the locations of the second connecting end 12 and the mounting member 22.

The above-mentioned embodiments are only some embodiments of the present application, and are not intended to limit the scope of the present application. Any equivalent structure conversion made with reference to the description and the accompanying drawings of the present application, directly or indirectly applied in other related technical fields, should all fall in the scope of the present application.

What is claimed is:

1. A wearable appliance for carrying a mobile device, comprising:
a flexible strip configured to encircle a user's neck, the flexible strip being capable of deforming to a shape when subjected to an external force and maintaining the shape of the flexible strip when the external force is removed, and
a mounting assembly connected to the flexible strip and configured to fix the mobile device.

2. The wearable appliance for carrying a mobile device according to claim 1, wherein the flexible strip is made of an aluminum bar and a covering material, and the covering material is covered on an outer surface of the aluminum bar.

3. The wearable appliance for carrying a mobile device according to claim 2, further comprising:
a steel wire, wherein the steel wire is wound onto the aluminum bar, and the covering material is covered on an outer surface of the steel wire.

4. The wearable appliance for carrying a mobile device according to claim 3, wherein the covering material comprises silicon, plastic, rubber or the mixture of them.

5. The wearable appliance for carrying a mobile device according to claim 1, wherein the flexible strip comprises:
a first connecting end; and
a second connecting end;
wherein, the first connecting end is fixed to the mounting assembly, and the second connecting end is detachably connected to the mounting assembly.

6. The wearable appliance for carrying a mobile device according to claim 5, wherein the mounting assembly comprises:
a housing provided with a plughole;
a first button movably mounted on the housing; and
a first locking member provided inside the housing and coupled to the first button;
wherein, the second connecting end is provided with a locking hole; the locking hole is locked with the first locking member when the second connecting end is inserted into the plughole, and the locking hole is unlocked with the first locking member when the first button is pressed down.

7. The wearable appliance for carrying a mobile device according to claim 6, wherein the first locking member comprises:
a first locking piece provided with an inserting latch perpendicular to the first locking piece; and
a first spring abutting against the first locking piece and the housing to provide an elastic force to the first locking piece;
wherein the first spring and the inserting latch are arranged on different sides of the first locking piece.

8. The wearable appliance for carrying a mobile device according to claim 6, wherein the first button is provided with an identification portion for indicating a location of the second connecting end.

9. The wearable appliance for carrying a mobile device according to claim 1, wherein the mounting assembly comprises a housing and a mounting member, the flexible strip is connected to the housing, and the mounting member is detachably connected to the housing, the mounting member is used to fix the mobile device.

10. The wearable appliance for carrying a mobile device according to claim 9, wherein the housing is provided with a mounting recess, an outer edge of the mounting recess is provided with one or more flanges, the mounting member comprises a mounting portion and a connecting portion, the mounting portion is configured to fit with the mounting recess and provided with one or more flanges on a periphery of the mounting portion, and the connecting portion is used to fix the mobile device.

11. The wearable appliance for carrying a mobile device according to claim 10, wherein the mounting assembly further comprises:
a second button; and
a second locking member coupled to the second button;
wherein, the second button is movably mounted on the housing, and the second locking member is provided inside the housing; the mounting portion is locked with the second locking member when the mounting member is rotated to a preset position in the mounting recess, and the mounting portion is unlocked with the second locking member when the second button is pressed down.

12. The wearable appliance for carrying a mobile device according to claim 11, wherein the connecting portion comprises:
a plurality of clamping plates arranged in parallel to each other and connected to the mounting portion;
a nut mounted on a clamping plate located at an outermost side of the plurality of clamping plates; and
a bolt;
wherein, each clamping plate is provided with a connecting hole, the nut is corresponded to the connecting hole, and the bolt is configured to be threaded through the connecting hole and threaded with the nut.

13. The wearable appliance for carrying a mobile device according to claim 9, wherein the mounting assembly further comprises:
a first magnetic piece; and
a second magnetic piece configured to attract the first magnetic piece by magnetic force;
wherein, the first magnetic piece is provided in the housing, and the second magnetic piece is provided in the mounting member.

14. The wearable appliance for carrying a mobile device according to claim 1, wherein the mounting assembly comprises:
a housing;
a mounting member detachably connected to the housing and configured to fix the mobile device;
wherein, the flexible strip comprises a first connecting end and a second connecting end, the first connecting end is fixed to the housing, and the second connecting end is detachably connected to the housing; the mounting assembly further comprises two buttons movably mounted on the mounting assembly, one of the two buttons is used to control the connection between the housing and the second connecting end, and the other button is used to control the connection between the mounting member and the housing; an end face of one of the two buttons exposed to an outer side of the housing is a concave surface, and an end face of the other button exposed to the outer side of the housing is a convex surface.

15. The wearable appliance for carrying a mobile device according to claim 1, wherein a hanging portion is formed at a middle of the flexible strip, and a diameter of the hanging portion is larger than diameters of other portions of the flexible strip.
